(19) United States
(12) Patent Application Publication
(10) Pub. No.: US 2006/0150786 A1
(43) Pub. Date: Jul. 13, 2006

(54) Plastic rivet puller pliers

(75) Inventors: Michael L. Whitehead, Clarinda, IA (US); Matt Blundell, Ontario (CA); Brian Semian, Cochranton, PA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/328,579

(22) Filed: Jan. 10, 2006

Related U.S. Application Data
(60) Provisional application No. 60/642,821, filed on Jan. 11, 2005.

(51) Int. Cl. B25B 7/00

(52) U.S. Cl. 81/300

(57) ABSTRACT

A pliers tool for removal of push pins used to join mechanical parts includes opposed jaw elements having a wedge configuration and a cylindrical passage in the tip of the wedge sections that prevents breaking of the shaft of a push pin during removal.

### CROSS REFERENCE TO RELATED APPLICATION

This is a utility application based upon, claiming priority to and incorporating by reference provisional application Ser. No. 60/642,821, filed Jan. 11, 2005.

### BACKGROUND OF THE INVENTION

In a principal aspect the present invention relates to a pliers type tool which is designed for use in the removal of push pins of types commonly employed in the manufacture of motor vehicles.

Molded polymeric push pins are utilized for multiple purposes in the assembly of motor vehicles. These push pins have a variety of configurations and constructions. For example, such push pins may employ a head mounted on a shaft wherein the shaft includes various flutes, barbs or projections for retaining the push pin within an opening through a frame or body member. Another construction for a push pin utilized in vehicle assembly comprises a two-part push pin assembly. A two-part push pin assembly employs an annular housing and a separate pin having a center shaft and head member. The shaft is fitted into the annular housing in order to lock the push pin and housing into position in an opening in a motor vehicle body or the like. Various other types of push pins are also utilized and variations in the construction of push pins of the types generally described are available. That is, the head and shaft constructions of two-part push pins may be varied. The annular housing may be varied. The dimensions, shaft configuration and head configuration may be varied.

Push pins of the type described are used, for example, to retain bumper housings, body panels, and other components of a motor vehicle attached to a body or frame member. Such push pins may also be used in other environments for other types of assembly such as for appliances, motor homes, toys and the like.

When repairing a motor vehicle or replacing parts of the vehicle, or when repairing other items which are assembled or retained in position by means of push pins, it is often necessary to remove the pins to dismantle parts for access to the underlying frame or substructure. Removal of such pins is preferably effected with a minimum amount of damage to the pin, as well as to the component part held in place by the pin. To effect such removal, various types of plier constructions and other tools have been proposed and/or utilized. Nonetheless, there has remained the need for a tool which provides adequate mechanical advantage to effect removal of pin while at the same time having a broad applicability, that is, to be useful for the removal of multiple types and shapes of push pins. These, among other features have inspired development of the present invention.

### SUMMARY OF THE INVENTION

Briefly, the present invention comprises a pliers configured tool made from first and second substantially identical plier elements. Each of the elements includes an elongate handle section or manual handle that extends along a generally straight, elongate axis. The elongate handle axis handle section is integrally connected with a run that forms an angle therewith in the range of about 40-50° with the axis. The connecting run includes a midpoint with an opening therethrough and a recessed section extending generally along the length of the connecting run. A jaw extension is integrally connected to and extends from the connecting run in a direction generally parallel to the elongate handle axis. The jaw extension further includes a gripping jaw member which extends generally transversely toward the elongate handle axis and which terminates with a wedge shaped member or section. The wedge shaped member or section is defined by an outer curved face and a generally flat, inclined plane, inner face. Further, the center of the end of the wedge shaped member or section includes a semi-cylindrical passage through the center thereof, or through the tip of the jaw member. The passage has an axis of rotation generally parallel to the elongate straight handle axis and midway between the spaced straight handle axes of the assembled tool.

That is, two of the pliers elements are assembled by being overlayed, one with respect to the other and retained together by means of a pivot pin or bolt and locking nut so that the assembly will have the general configuration of a pliers that can be used to engage the head of a push pin and effectively remove the push pin from a retention opening. The semi-cylindrical passage through the tip of the jaw is designed so that the jaw tip may fit around and under the head of a push pin without cutting the shaft of the push pin while enabling the tool to tightly grip the push pin and effect removal from the article in which the push pin is placed. Single and two-part push pins may be effectively removed using the tool. The inclined plane or wedge surface of the push pin may be used to fit or be slipped under the head of a two-part push pin assembly or into a slot associated with a construction of a two-part push pin assembly to wedge the center headed push pin from the annular housing or element. The pliers construction of the invention thus has applicability for removal of multiple types of push pins without damaging the push pin and, in particular, without removing the head from the shaft of the push pin.

### BRIEF DESCRIPTION OF THE DRAWING

In the detailed description which follows, reference will be made to the drawing comprised of the following figures:

FIG. 1 is a side view of the tool of the invention;

FIG. 2 is a top plan view of the tool of FIG. 1;

FIG. 3 is a left hand end view of the tool of FIG. 1;

FIG. 4 is a right hand end view of the tool of FIG. 1;

FIG. 5 is a side elevation of one of the plier elements of the tool of FIG. 1;

FIG. 6 is a top plan view of the element of FIG. 5;

FIG. 7 is an enlarged side view of the jaw construction of the tool of FIG. 5;

FIG. 8 is an exploded isometric view of the tool of FIG. 1;

FIG. 9 is a section view wherein the tool of the invention is used with a headed fastener of a two-part push pin;

FIG. 10 is a sectional view wherein the tool of the invention is utilized with a push pin having a single head and single shaft;

FIG. 11 is an isometric view depicting the utilization of the tool of the invention with a two-part push pin wherein the head of the push pin center section is recessed within a slot in the annular member of the push pin assembly; and

FIG. 12 is an isometric view of the manner of use of the tool of the invention with respect to a push pin of the type depicted in FIG. 11.

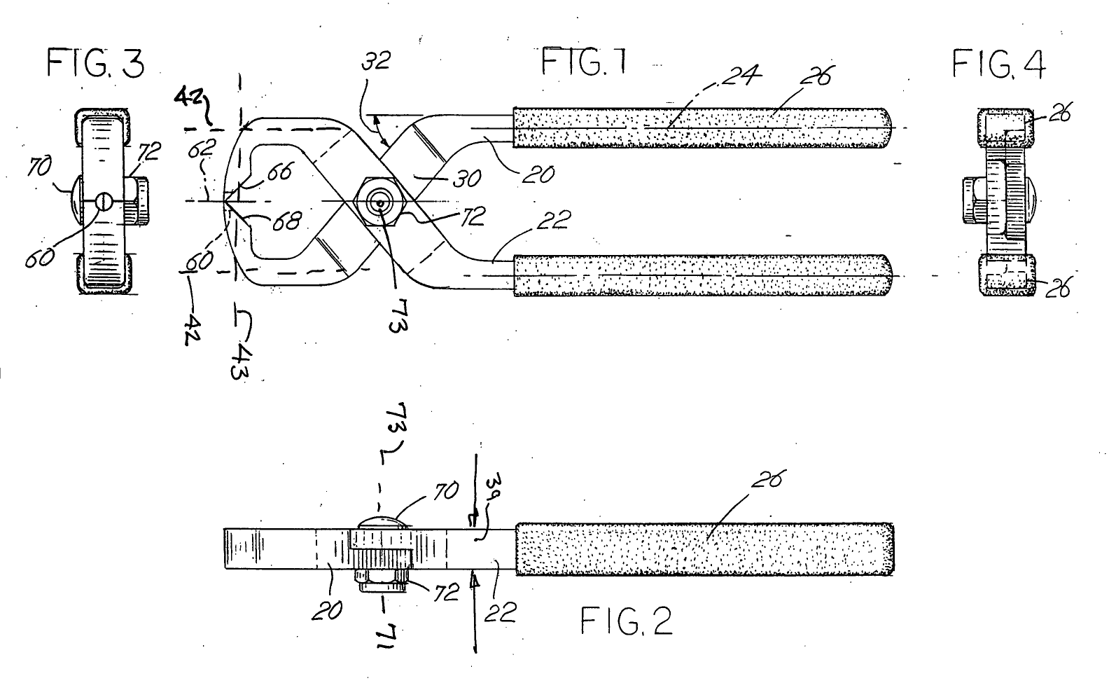

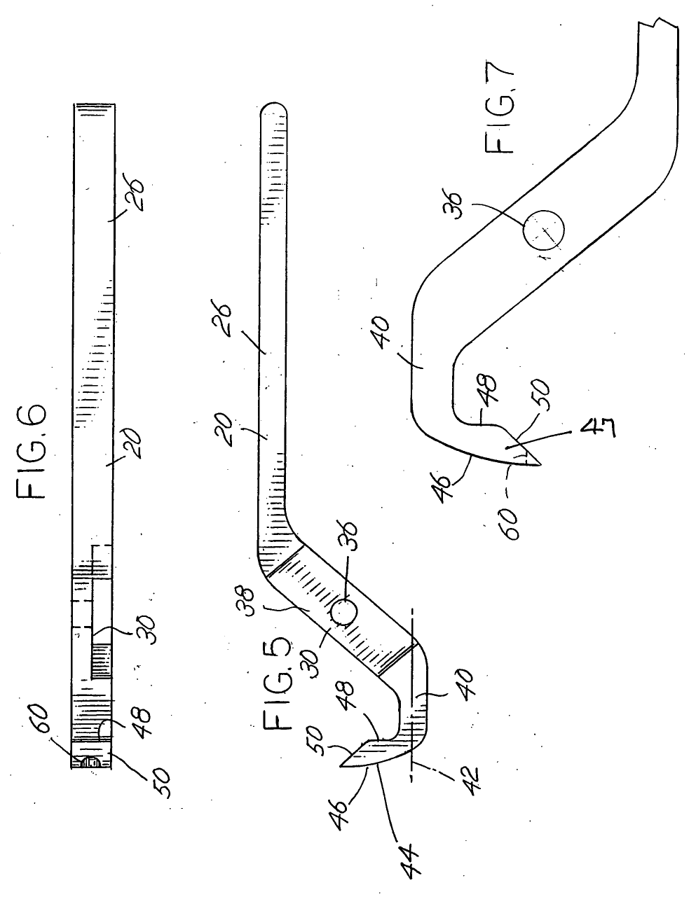

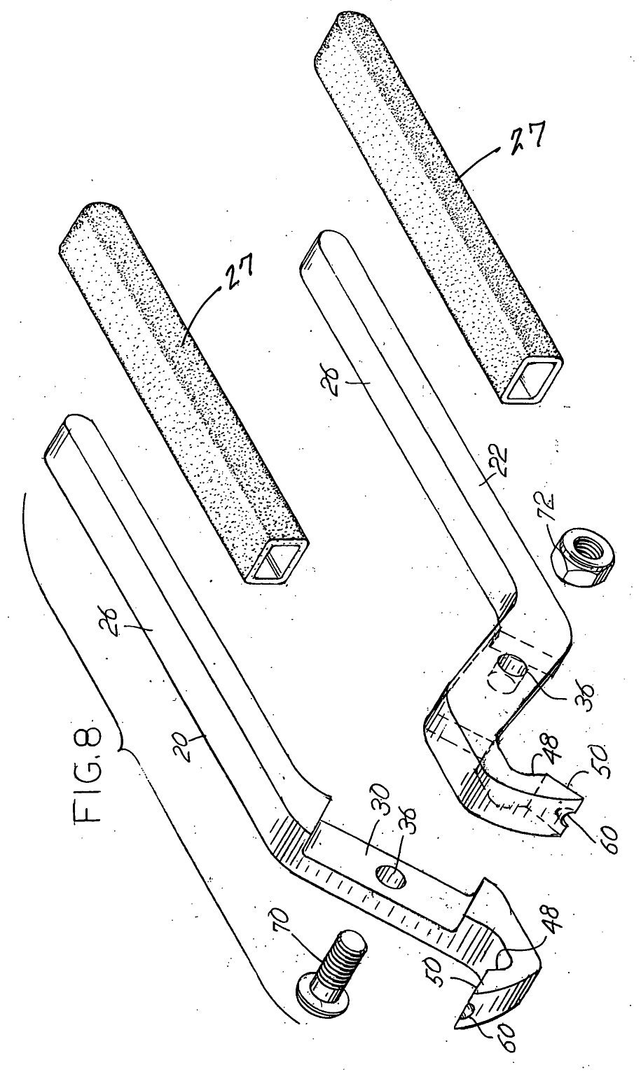

### DESCRIPTION OF THE PREFERRED EMBODIMENT

Referring to the figures, the tool of the invention comprises and generally has the configuration of a pliers or type tool. The pliers type tool is comprised of first and second substantially identical pliers subparts or elements 20, 22. Thus, a description of one of the pliers elements utilized in the tool applies to the other element. Referring to the figures, the pliers element 20 includes an elongate longitudinal straight line axis 24 associated with a generally elongate straight handle section 26. In practice, the handle section 26 is covered by a vinyl or coated plastic grip 27 to facilitate comfort during use of the tool.

The elongate handle section 26 is a generally straight section integrally connected to intermediate run 30 that extends at an angle 32 in the range of 40-50° with respect to handle section 26. The angle 32 is defined by the angle between the axis 24 and the elongate integral connecting run 30. That is, referring to the figures, an angle 32 is defined between the connecting run 30 and the axis 24. The connecting run 30 is a generally straight line element and includes a midpoint or center passage or opening 36 and further includes a recessed section 38 relative to handle section 26 which extends substantially from the elongate handle 26 to the initial portion of a jaw 40. The recessed section 38 is provided so that the two pliers elements 20 and 22 may be matched or faced one against the other and provide thereby a configuration having a uniform width 39 as depicted, for example, in FIG. 2. The thickness of each section 38 is thus one half (½) of the width 39 of the combined elements 20, 22. Typically, the handle sections 26 have a uniform width 39.

The jaw or jaw extension 40 extends along an axis 42 which is generally parallel to the axis 24 and spaced a distance therefrom determined by or defined by the integral connecting run 30. The jaw extension 40 further includes an upwardly or inwardly extending gripping jaw member 44 which extends generally along an axis 43 transverse or normal to the axis 42 and which is defined by an arcuate or a curved outer face 46 and an inner face 48. The inner face 48 connects with an inclined, generally flat face 50 that extends outwardly and intersects the curved outer face 46. In this manner, a wedge configuration 47 is formed. The configuration or wedge 47 that is formed includes, at its distal or outer end, a generally semi-cylindrical passage or opening 60 having an axis of rotation 62 which is generally parallel to the axes 24 and 42. In this manner, there is defined on each side of the opening or passage 60 a sharp inclined wedge section 66 and 68 spaced one from the other by the opening or passage 60. When so assembled, the elements 20, 22 include axes that have various preferred relationships. Thus, axis 24 of element 20 is generally coincident with axis 42 of element 22. Axis 24 of element 20 is generally coincident with axis 42 of element 22. Axis 62 is midway between and parallel to axes 42 of elements 20, 22. Axis 62 intersects axis 73 at a right angle. Axis 62 intersects axis 43 of a right angle. The handle axes 42, jaw extension axes 42, jaw axis 43 and passage axis 62 are all generally coplanar.

The pliers elements 20 and 22 are retained, notably connected to each other by means of a bolt 70 and a nut 72 which wherein the bolt includes a shaft 71 with axis 73 fitted through the openings 36 of the respective elements 20 and 22. Axis 73 is normal to axis 62.

The figures beginning with FIGS. 9-12 illustrate in detail how the tool of the invention may be utilized to remove various types of push pins. That is, one type of push pin, for example, as depicted in FIG. 9, includes a head 80 and a shaft 82 with projecting barbs or flanges 84 mounted in an annular tube or housing 86. The tool of the invention is designed so that the wedge shaped sections 47 will fit under the head 80 but not cut the shaft 82 of the push pin and may be then clamped against the push pin so that the push pin may be pulled and removed. The annular tube 86 may then be gripped by the wedge sections 47 and pulled from the opening 90 in the sheets 92, 93. Again, because of the semi-cylindrical passages 60, the tool avoids cutting or breaking the tube 86 during removal.

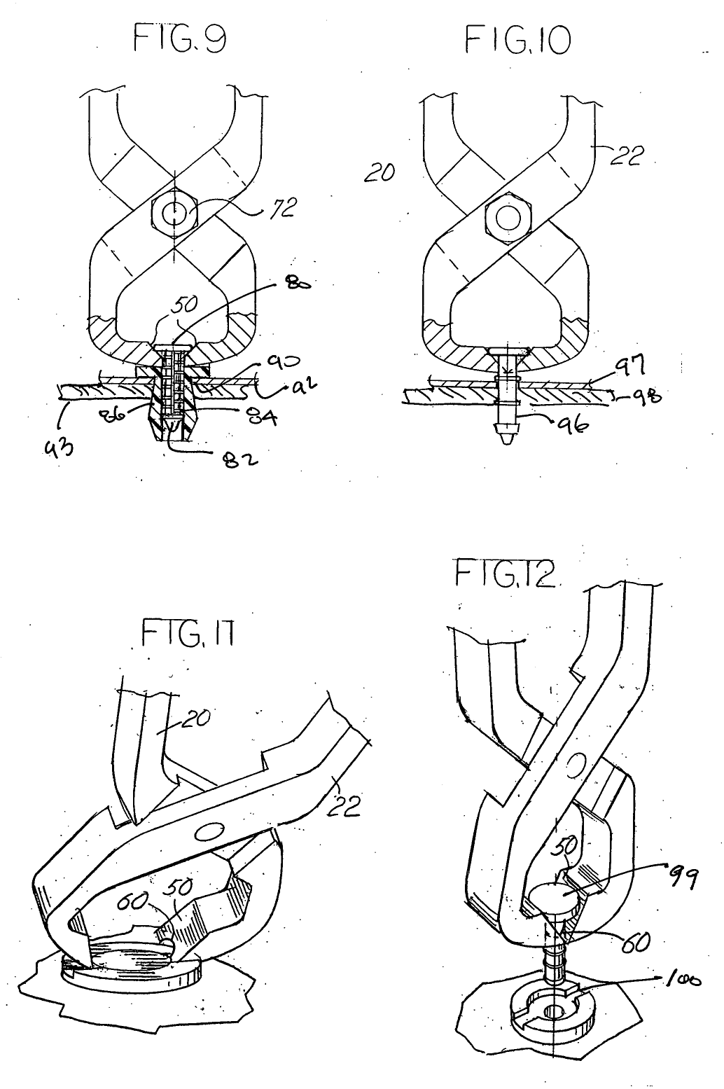

FIG. 10 illustrates removal of a push pin 96 from sheets or joined members 97, 98 using the tool. Flutes of the pin 96 are effectively pulled through the mated opening of the joined members 97, 98 without removing or cutting the shaft of the pin 96.

FIGS. 11 and 12 also depict how the tool of the invention might be utilized in combination with a two-part push pin construction as shown in FIG. 9. Note that the wedge sections 47 and/or 47 may be used when the push pin head 99 is recessed in a slot 100 by gripping the push pin head 99 to initiate removal. This is accomplished by canting the tool slightly as depicted in FIG. 11. After the push pin head is partially removed from such a push pin construction, the pliers tool may be reoriented so that the openings or passages 60 are aligned with the shaft of the push pin 96 to complete the removal from an annular housing associated with the push pin assembly.

The tool construction of the invention is designed for comfort as well as aesthetics. The arrangement of the axes and the utilization of various design elements for the tool provide an aesthetic and pleasingly appearing tool while at the same time providing a tool which is highly efficient, compact, rugged and easy to use.

While there has been set forth a preferred embodiment of the invention, it is to be understood that the invention is limited only by the following claim and equivalents thereof.

What is claimed is:

1. A push pin removal pliers tool comprising, in combination:
first and second substantially identical pivotally connected plier elements, each plier element including an elongate handle with a generally straight line elongate handle axis, an integral connecting run forming an angle in the range of about 40-50° with said handle axis and including a generally midpoint pivot opening with a pivot axis normal to the handle axis, and a recess section extending generally along the length of the connecting run, each plier element further including,
a jaw extension from the connecting run, said jaw extension having a jaw extension axis generally parallel to the handle axis, and a gripping jaw member extending from the jaw extension generally normal to the extension axis and extending toward the handle axis, said jaw terminating with a wedge shaped member defined by an arcuate outer face, an inclined plane, flat inner face forming a wedge shape, and a center, generally semi-cylindrical opening in the tip of the jaw with an opening axis of rotation parallel to the handle axis; and
a pivot connection mechanism for pivotally connecting the plier elements with the gripping jaw members in opposed relation, said pivot connection mechanism having a pivot axis generally normal to the handle axes, said handle axes, jaw extension axes and transverse axes of rotation generally coplanar, said wedge shape of said plier elements in opposed relation to provide a cylindrical passage.

2. The tool of claim 1 wherein the pivot connection axis is substantially midway between the handle axes and intersects the passage axis when the tool is in a closed position with the wedge members of the separate pliers elements is substantial contact.

3. The tool of claim 2 wherein the connecting run has a dimension normal to the axis substantially one half (½) of the parallel dimension of the elongate handle.

4. The tool of claim 3 wherein the dimension of the jaw extension normal to the axis is the same as the dimension of the elongate handle normal to the handle axis.
